(19) United States
(12) Patent Application Publication
(10) Pub. No.: US 2013/0305181 A1
(43) Pub. Date: Nov. 14, 2013

(54) INPUT DEVICE

(71) Applicant: Katsuhiko UMETSU, Osaka-shi, Osaka (JP)

(72) Inventor: Katsuhiko Umetsu, Osaka-shi (JP)

(73) Assignee: SHARP KABUSHIKI KAISHA, Osaka-shi, Osaka (JP)

(21) Appl. No.: 13/980,983

(22) PCT Filed: Feb. 3, 2012
(86) PCT No.: PCT/JP2012/052459

§ 371 Date: Jul. 22, 2013

(30) Foreign Application Priority Data
Feb. 8, 2011 (JP) 2011-024993

(51) Int. Cl. G06F 3/0488

(52) U.S. Cl. CPC G06F 3/04886
USPC 715/773

(57) ABSTRACT

Through operation of a software keyboard displayed on the screen, and without creating physical protrusions or depressions, this input device enables easy and reliable key operations even without visual confirmation of the keyboard. A display portion of a touch panel displays a software keyboard having a prescribed array of keys. An input portion is attached to the display portion, and is capable of user input operations. Based on the user's touch position on the touch panel, a control portion determines if said touch position is in a specific position pre-set as the home position of the software keyboard. When the touch position is in the specific position, a notification portion notifies the user by a prescribed notification. By this means, the user can determine when he or she touches the home position while performing touch operations even without visual confirmation of the software keyboard.

### TECHNICAL FIELD

The present invention relates to an input device, and more particularly to an input device that displays a software keyboard to enable operation input on the software keyboard.

### BACKGROUND OF THE INVENTION

Keyboards are used as common operation input means of information processing devices such as PCs and mobile terminal devices. When a user operates a keyboard, a home position is commonly fixed. The home position refers to a proper position to place a finger in so-called touch typing that a user performs input without looking at a keyboard, for example. In the touch typing, a hand position is required to be always fixed, and each finger has a fixed position on the keyboard.

For example, in the case of a physical QWERTY keyboard, each of the “F” key and the “J” key is provided with a small bump portion, and touching the bump portion allows the forefinger of the left hand or the forefinger of the right hand to be placed on each of the keys. Moreover, in the case of a numerical keypad, a home position is allowed to be found with a bump portion provided on the “5” key.

On the other hand, software keyboards have been widely used in recent years as well as physical keyboards. On a software keyboard, software realizes input processing originally performed by a keyboard, and input is performed with a user's finger with use of a touch panel or input of each key is performed with use of a mouse, a pen or the like on a keyboard (character palette) displayed on a screen. Such a software keyboard is naturally not allowed to have a bump portion provided thereon like the physical keyboard described above.

Regarding a technology of improving operability on a software keyboard, for example, Patent Literature 1 discloses an information input/display device which is available for blind touch for inputting information and grasping display information even while watching a work object. In this device, a bundle of optical fibers is arranged at a cover part tightly adhered to a touch display, the position and shape of an input block are determined from block information by a block recognizing function of a cover control part, and the length of the optical fiber corresponding to the position is controlled by an actuator. Thereby, a bump is formed on a cover plane, blocks with tactile senses different from each other are provided, and these tactile senses allow the blind touch.

Further, Patent Literature 2 discloses an information processor having a software keyboard with an aim of enabling high speed input such as executing blind typing. This information processor is configured so that, when a software keyboard is displayed on a liquid crystal display, a keyboard input auxiliary part with a bump is placed on the upper part of a part on which the software keyboard is being displayed. Thereby, a user is allowed to sense a feeling of input with tactile in the same way as an ordinary keyboard to improve a user's feeling of input and to execute high speed input such as executing blind typing.

### PRIOR ART DOCUMENT

### Patent Documents

Patent Document 1: Japanese Laid-Open Patent Publication No. 1997-319518
Patent Document 2: Japanese Laid-Open Patent Publication No. 1994-332602

### SUMMARY OF THE INVENTION

### Problem to be Solved by the Invention

As described above, a physical keyboard is provided with a bump portion to confirm a home position, however, in a common software keyboard, the home position is not allowed to be confirmed with the bump portion, so that operation input needs to be performed while visually confirming the keyboard, thus deteriorating operability. Further, there arises a problem that a person having visual impairments is unable to visually confirm a software keyboard, thus unable to perform operation input itself well, for example.

The above-described device of Patent Literature 1 is provided with the blocks with tactile senses different from each other by forming the bump on the cover plane of the touch display. Further, in the device of Patent Literature 2, the keyboard input auxiliary part with the bump is placed on the upper part of the part on which the software keyboard is being displayed. In other words, in each of the cases, a physical bump is formed on a screen to operate a software keyboard. However, a configuration to form such a physical bump is not allowed to deal with such an operation only by processing with software, a mechanical configuration for forming a bump is required separately, and thus the configuration becomes complicated.

The present invention is devised in view of circumstances as described above, and aims to provide a key input device that enables an easy and reliable key operation even without visual confirmation of a software keyboard through an operation of the keyboard displayed on a screen, without creating a physical bump.

### Means for Solving the Problem

To solve the above problems, a first technical means of the present invention is an input device, comprising: a touch panel including a display portion that displays a software keyboard having predetermined key arrangement and an input portion attached to the display portion; a control portion that determines, based on a user's touch position on the touch panel, whether the touch position is in a specific position preset as a home position of the software keyboard; and a notification portion that makes predetermined notification to the user in accordance with control by the control portion when the touch position is in the specific position.

A second technical means is the input device of the first technical means, wherein the specific position preset as the home position is set as an area of a specific key displayed by the software keyboard, the control portion determines from a trajectory of the touch position on the touch panel whether the touch position moves in either direction of a horizontal direction or a vertical direction on a display screen of the display portion, and in the case of determining that the touch position moves in the horizontal direction, judges whether the touch position is in the specific position based on whether or not the touch position falls within a range of the horizontal direction in an area for the specific key, and in the case of determining that the touch position moves in the vertical direction on the display screen, judges whether the touch position is in the specific position based on whether or not the touch position falls within a range of the vertical direction in the area for the specific key.

A third technical means is the input device of the second technical means, wherein the control portion selects a predetermined-range trajectory from trajectories of the touch positions, extracts a movement component in the horizontal direction and a movement component in the vertical direction of the selected trajectory, compares the extracted movement component in the horizontal direction to the extracted movement component in the vertical direction, and determines that a direction corresponding to a component with a larger amount of movement is a direction in which the touch position moves.

A fourth technical means is the input device of the first technical means, wherein the specific position set as the home position is a center position of the specific key displayed by the software keyboard.

A fifth technical means is the input device of the first technical means, wherein the specific position set as the home position is a boundary position between an area for the specific key displayed by the software keyboard and an area outside the area for the specific key.

A sixth technical means is the input device of any one of the first to the fifth technical means, wherein the notification means includes any or a plurality of a vibrator for making notification by oscillation, a light source for making notification by emitting light, and a speaker for making notification by audio output.

A seventh technical means is the input device of any one of the first to the sixth technical means, wherein the notification portion changes a state of notification according to a distance between the user's touch position on the touch panel and the specific position.

### Effect of the Invention

It is possible to provide a key input device that enables an easy and reliable key operation even without visual confirmation of a software keyboard through an operation of the keyboard displayed on a screen, without creating a physical bump.

### BRIEF DESCRIPTION OF DRAWINGS

FIG. 1 is a block diagram showing a configuration example of an input device according to the present invention.

FIG. 2 is a diagram for explaining a determination processing example for an input operation on the input device according to the present invention.

FIG. 3 is a diagram for explaining a method for determining a movement direction based on a trajectory of a touch position on a touch panel.

FIG. 4 is a diagram for explaining a determination processing example of a home position on a software keyboard.

FIG. 5 is another diagram for explaining a determination processing example of the home position on the software keyboard.

### PREFERRED EMBODIMENT OF THE INVENTION

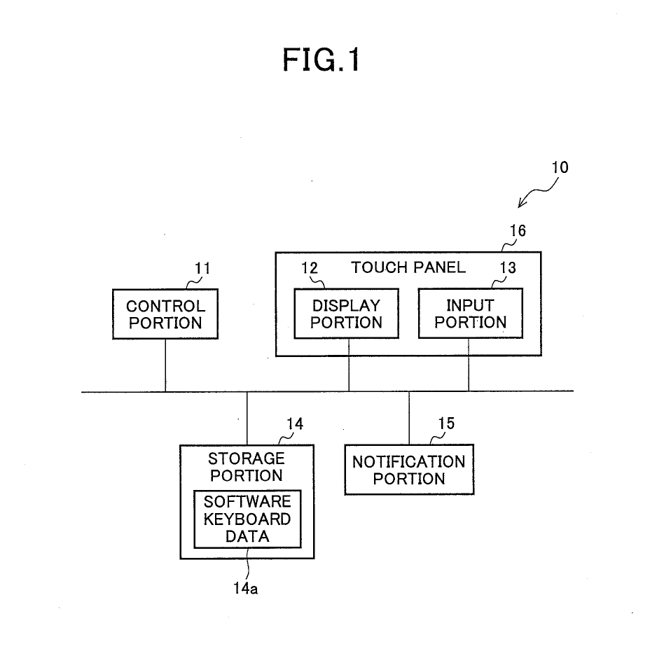

FIG. 1 is a block diagram showing a configuration example of an input device according to the present invention. An input device 10 in this example includes a control portion 11, a storage portion 14, a notification portion 15 and a touch panel 16. The touch panel 16 is composed of a display portion 12 and an input portion 13.

The storage portion 14 is a storage means using various types of memories, HDDs and the like for storing various types of programs and data, and also storing software keyboard data 14a to be displayed on the display portion 12.

The control portion 11 executes the various types of programs stored in the storage portion 14 to control each portion of the device. Further, the control portion 11 reads the software keyboard data 14a stored in the storage portion 14 to be displayed on the display portion 12.

The display portion 12 of the touch panel 16 is a display means such as an LCD (liquid crystal display) for displaying a software keyboard. The input portion 13 is an input means of a pressure sensitive type or the like that is provided on a surface of the display portion 12, and is used for detecting operation input of a user. Operation input information by a user performed on the input portion 13 is output to the control portion 11, and the control portion 11 is allowed to control a display state of the display portion 12 based on the operation input information.

Based on a user's touch position on the touch panel 16, the control portion 11 determines whether the touch position is in a specific position preset as a home position of the software keyboard. When the touch position is then in the specific position, the notification portion 15 is controlled to make predetermined notification to the user.

The notification portion 15 includes and operates any or a plurality of a vibrator for making notification by oscillation, a light source for making notification by emitting light and a speaker for making notification by audio output, thereby making notification to the user.

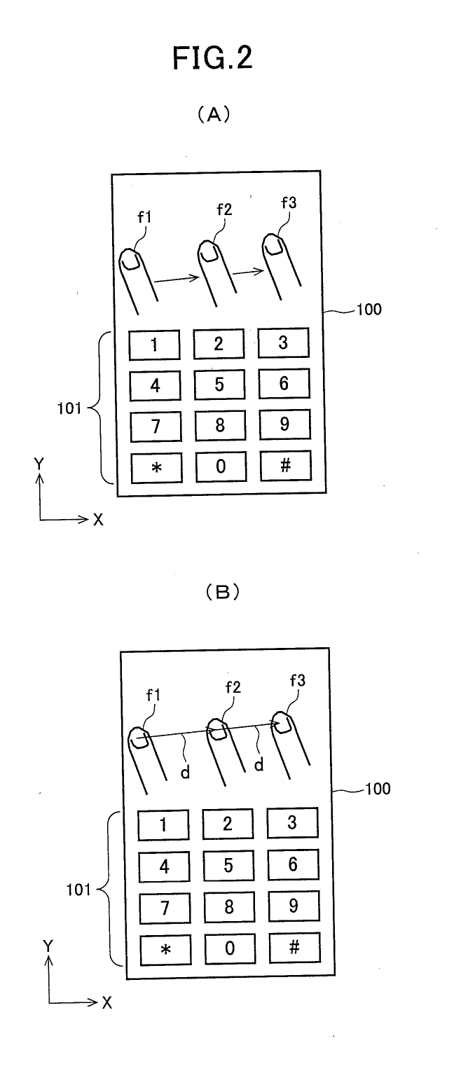

FIG. 2 is a diagram for explaining a determination processing example for an input operation on the input device according to the present invention. A display screen 100 shows an example of a screen to be displayed on the display portion 12 of FIG. 1, where a software keyboard 101 with a numerical keypad is displayed. As described above, the input portion 13 of the touch panel 16 is provided on the display screen of the display portion 12, and a user is allowed to perform operation input with his/her finger or the like.

Here, as shown in FIG. 2(A), a user performs action for sliding his/her finger that touches the touch panel 16. The position of the finger moves on the touch panel 16, in order of f1, f2 and f3. At the time, a trajectory of the finger's touch position on the touch panel 16 is formed as indicated by a trajectory d in FIG. 2(B). Such an input operation on the touch panel 16 is analyzed by the control portion 11.

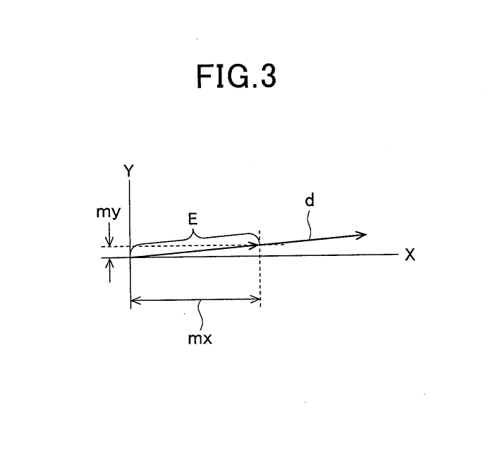

FIG. 3 is a diagram for explaining a method for determining a movement direction based on a trajectory of a touch position on the touch panel. Here, when a horizontal direction is an X direction and a vertical direction is a Y direction on the display screen 100, the trajectory d of the touch position on the touch panel 16 is recorded diagonally right upward from the left.

The control portion 11 analyzes the trajectory d of the touch position. Here, a predetermined-range trajectory is selected from the entire trajectory d, and the amount of movement mx as a component in the X direction is compared to the amount of movement my as a component in the Y direction in the trajectory d in the selected range. In an example of FIG. 3, a predetermined range E is selected to compare mx and my. Consequently, mx>my is achieved, and it is thus determined that the finger describing the trajectory d has moved in the X direction. Conversely, in the case of mx<my, it is possible to determine that the finger describing the trajectory d has moved in the Y direction. Here, in the case of mx=my, it may be defined in advance so that it is determined that the finger would have moved in either of the X direction or the Y direction.

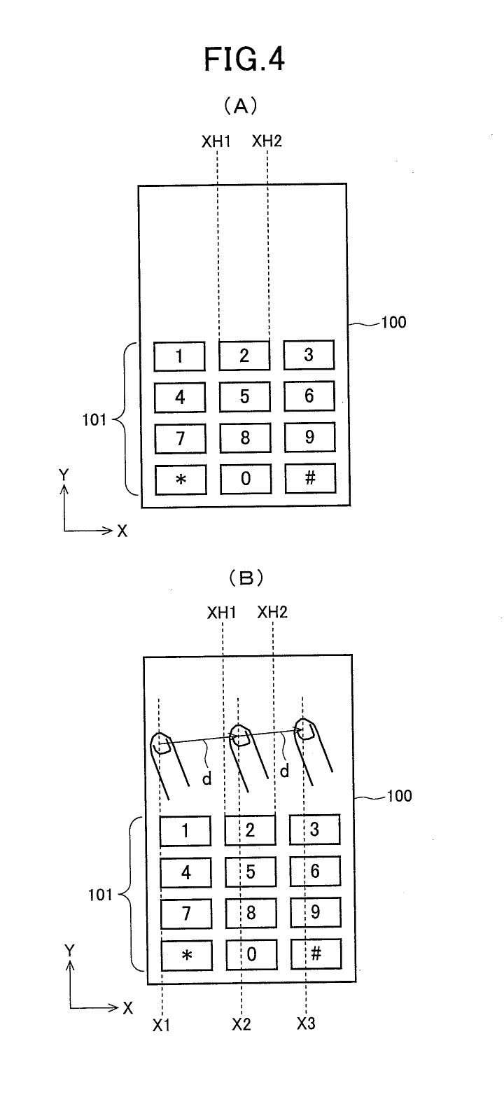

FIG. 4 is a diagram for explaining a determination processing example of a home position on the software keyboard. The control portion 11 of the input device 10 sets, in the case of displaying the software keyboard 101 on the display screen of the display portion 12, a specific position indicating the home position in a display area (operation area) of the display screen 100. In the case of this example, the specific position is set as an area having certain ranges in the X direction and the Y direction.

FIG. 4(A) shows an area of the home position in the X direction. Here, the area of the home position in the X direction falls within a range from XH1 to XH2 including a key “5” of the software keyboard.

The control portion 11 determines, in the case of determining by the above-described determination processing of a movement direction shown in FIG. 3 that a movement direction of the trajectory d of the touch position is the X direction, whether or not the touch position falls within the area in the X direction of the home position. Here, in a case where a coordinate in the X direction of the touch position is x, when the relationship of XH1≦x≦XH2 is established, it is determined that the touch position is in the area of the home position.

For example, as shown in FIG. 4(B), a coordinate in the X direction of the trajectory d of the touch position proceeds from X1 to X2, and further to X3. In this case, when the touch position x falls within a range of x<XH1, it is judged that the touch position x is outside the area of the home position. For example, the touch position of X1 is outside the area.

When the touch position x then falls within a range of XH1≦x≦XH2, it is judged that the touch position x is in the home position. For example, it is judged that the touch position of X2 is in the home position. When the touch position x then falls within a range of XH2<x, the touch position x is outside the area of the home position. The touch position of X3 is outside the area.

In this manner, the control portion 11 is allowed to judge, in the case of judging that the movement direction of the touch position is the X direction, whether the touch position is in the home position in the X direction or whether the touch position is outside the range of the home position, according to a user's touch position on the touch panel 16.

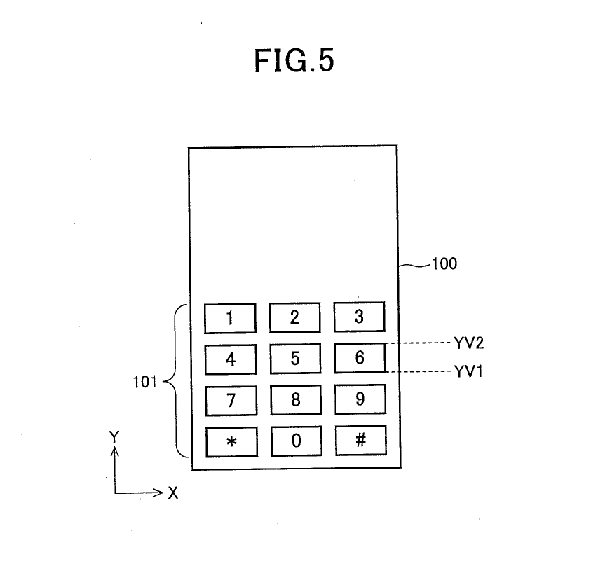

Additionally, the same processing is also performed for the Y direction. For example, as shown in FIG. 5, the area of the home position in the Y direction is set to a range from YV1 to YV2. In other words, here, the control portion 11 judges, in the case of judging by the judgment processing in FIG. 3 that a moving direction of the trajectory d of the touch position is the Y direction, when a coordinate y in the Y direction of the touch position falls within a range of y<YV1, that the touch position y is outside the area of the home position. When the touch position y then falls within a range of YV1≦y≦YV2, it is judged that the touch position y is in the home position. Further, when the touch position y falls within a range of YV2<y, the touch position y is outside the area of the home position.

In this manner, it is judged whether or not the touch position is in the home position in the X direction or the Y direction according to a direction in which a user moves the touch position. In other words, when the user moves the touch position in the X direction, it is judged whether or not the touch position is in the home position in the X direction, and when the user moves the touch position in the Y direction, it is judged whether or not the touch position is in the home position in the Y direction.

It is possible to appropriately perform setting of the area of the home position as described above according to a display state of the software keyboard. In the above-described example, when the software keyboard with the numerical keypad is displayed, the area in the X direction and the area in the Y direction corresponding to the key “5” are set as the area of the home position. Further, for example, in the case of a QWERTY software keyboard, it is possible to set areas of the “F” key and the “J” key as the area of the home position.

Moreover, as another example of the judgment processing of the touch position, it may be judged, based on the coordinates of x and y of the touch position, whether or not the touch position falls within the area of the home position without judging the movement direction of the touch position as described above. In this case, coordinate values of x and y are defined in advance so as to allow determination of the area of the home position. For example, coordinate values of four corners of a rectangle on a display screen are preset, and it is defined that the area of the home position is within the rectangle. Then, the control portion 11 judges, based on the touch position on the input portion 13, whether the touch position falls within or is outside the area of the home position.

In each of the above-described examples, the control portion 11 causes the notification portion 15, in the case of judging by the above-described processing whether or not a user's touch position is in the home position, when the touch position is in the home position, to make notification to the user by a predetermined method.

For example, a vibrator is provided as the notification portion 15, and actuated to cause oscillation when the touch position is in the home position. This allows a user to recognize his/her touch of the home position while touching the input portion 13.

As another example of the notification portion 15, a speaker is provided to make notification to a user by outputting predetermined audio when the touch position is in a home position.

Additionally, as yet another example of the notification portion 15, a light source for emitting light by an LED is provided and causes the LED to emit light when the touch position is in the home position. Light may be continuously emitted or blinked. Notification by emitting light may be applied to a person having visual impairments who is just enough to visually confirm brightness, however, is unsuitable for a person having visual impairments who cannot recognize light emission at all.

Any of the above-described examples are allowed to be applied as a notification means of the notification portion 15, and additionally, a plurality of these examples may be combined to be operated simultaneously.

Further, a condition may be defined where the notification portion 15 notifies that the area of the home position is touched. For example, the above-described notification portion 15 may be operated each time it is determined that a user touches the area of the home position, or only when the area of the home position is first touched, the notification portion 15 may be operated. Touching the area first may be defined as touching the area first after the input device 10 is powered on, for example. Alternatively, in a case where the touch panel has not been touched during a predetermined time, when the area of the home position is first touched after the elapse of the predetermined time, the notification portion 15 may be operated.

Moreover, when the above-described notification portion 15 is operated, an operating state of the notification portion 15 may be changed according to the distance between the touch position and the area of the home position. In this case, the control portion 11 of the input device 10 discriminates the distance between the preset area of the home position and the touch position based on the touch position detected by the input portion 13, and changes the operating state of the notification portion 15 according to the distance. For example, it is possible to apply great oscillation by making vibration stronger as the distance between the touch position and the area of the home position is longer, and to make vibration gradually weaker as the distance is gradually shorter.

Additionally, as another example, a blinking interval of the LED may be shorten as the distance between the touch position and the area of the home position becomes longer, and the blinking interval may be made gradually longer as the distance becomes gradually shorter. Alternatively, brightness for emitting light by the LED may be controlled to make emission intensity greater as the distance between the touch position and the area of the home position becomes longer.

Further, in yet another example, sound volume of predetermined audio output may be increased as the distance between the touch position and the area of the home position becomes longer, and the sound volume may be gradually decreased as the distance gradually shortens.

In a case where the operating state of the notification portion 15 is changed according to the above-described distance between the touch position and the area of the home position, it is possible to judge a movement direction of a user's touch position to determine the distance between the home position and the touch position according to the judgment result. For example, when the movement direction is the X direction, the distance between a position in the X direction of the touch position and a boundary in the X direction of the area of the home position is discriminated, and the operating state of the notification portion 15 is changed according to the distance. In this case, since it is possible to judge the movement direction of the touch position only by moving at a certain level of distance, the operating state of the notification portion 15 may be controlled to be changed when the judgment result of the movement direction is available.

Moreover, the distance between the touch position and the area of the home position may be determined according to a coordinate of the touch position without judging the movement direction of the touch position. In this case, the nearest direct distance between the coordinate of the touch position and the preset area of the home position is calculated as the distance between the touch position and the area of the home position, and the operating state of the notification portion 15 may be changed according to the distance.

Additionally, in each of the above-described examples, the area of the home position is defined in advance to make predetermined notification when the touch position falls within the area, however, the center point of a target key for the home position may be defined as the touch position to be notified, rather than defining the home position as an area. For example, it is possible to set a center coordinate position of the key “5” in the software keyboard with the numerical keypad so as to be notified as the home position. When a user's touch position on the touch panel is then in the center position of the key “5”, it is possible to make the predetermined notification. In this case, the touch position to be notified may be defined as an area of a certain size having the center point of a predetermined key as the center.

Further, in another example, predetermined notification to be only notified of a boundary of an area set as the home position may be made when the touch position is on the boundary or when the touch position passes over the boundary. In other words, a specific position to be notified is a boundary position between the area set as the home position and an area outside the set area.

Moreover, in the case of having a large number of keys like keys of a QWERTY keyboard, it is possible to set the area of the home position for a plurality of keys of “F”, “J” and the like as described above, and also in this case, respective center positions of a plurality of keys and a plurality of boundaries of the areas of the home position may be set to be notified. Further, in this case, for each of the plurality of keys, oscillation strength of a vibrator, emission intensity of an LED, sound volume of audio output and the like may be changed so that a user recognizes which key is set to be notified.

### EXPLANATIONS OF LETTERS OR NUMERALS

10 . . . input device; 11 . . . control portion; 12 . . . display portion; 13 . . . input portion; 14 . . . storage portion; 14a . . . software keyboard data; 15 . . . notification portion; 16 . . . touch panel; 100 . . . display screen; and 101 . . . software keyboard.

1.-7. (canceled)

8. An input device, comprising:
a touch panel including a display portion that displays a software keyboard having predetermined key arrangement and an input portion attached to the display portion;
a control portion that determines, based on a user's touch position on the touch panel, whether the touch position is in a specific position preset as a home position of the software keyboard; and
a notification portion that makes predetermined notification to the user in accordance with control by the control portion when the touch position is in the specific position, wherein
when a horizontal direction is an X direction, a vertical direction is a Y direction in the display portion,
a coordinate area in the X direction of the specific position is a range from XH1 to XH2, a coordinate area in the Y direction of the specific position is a range from YV1 to YV2, a coordinate in the X direction of the touch position is x, and a coordinate in the Y direction of the touch position is y,
the control portion determines that the touch position is in the specific position when either one of XH1≦x≦XH2 or YV1≦y≦YV2 is satisfied.

9. The input device as defined in claim 8, wherein
the control portion determines from a trajectory of the touch position on the touch panel whether the touch position moves in either direction of a horizontal direction or a vertical direction on a display screen of the display portion, and in the case of determining that the trajectory of the touch position moves in the horizontal direction, judges whether or not the touch position is in the coordinate area in the X direction of the specific position, and in the case of determining that the trajectory of the touch position of the control portions moves in the vertical direction, judges whether or not the touch position is in the coordinate area in the Y direction of the specific position.

10. The input device as defined in claim 9, wherein
the control portion selects a predetermined-range trajectory from trajectories of the touch positions, extracts a movement component in the horizontal direction and a movement component in the vertical direction of the selected trajectory, compares the extracted movement component in the horizontal direction to the extracted movement component in the vertical direction, and determines that a direction corresponding to a component with a larger amount of movement is a direction in which the touch position moves.

11. The input device as defined in claim 8, wherein
the specific position set as the home position is a center position of the specific key displayed by the software keyboard.

12. The input device as defined in claim 8, wherein
the specific position set as the home position is a boundary position between an area for the specific key displayed by the software keyboard and an area outside the area for the specific key.

13. The input device as defined in claim 8, wherein
the notification portion includes any or a plurality of a vibrator for making notification by oscillation, a light source for making notification by emitting light, and a speaker for making notification by audio output.

14. The input device as defined in claim 8, wherein
the notification portion changes a state of notification according to a distance between the user's touch position on the touch panel and the specific position.
